(19) United States
(12) Patent Application Publication
(10) Pub. No.: US 2025/0005793 A1
(43) Pub. Date: Jan. 2, 2025

(54) GRADUATION-PLATE POSTURE INSPECTION METHOD

(71) Applicant: MITUTOYO CORPORATION, Kanagawa (JP)

(72) Inventors: Masaaki SHIMIZU, Hokkaido (JP); Kasumi KONDO, Kanagawa (JP)

(73) Assignee: MITUTOYO CORPORATION, Kanagawa (JP)

(21) Appl. No.: 18/754,677

(22) Filed: Jun. 26, 2024

(30) Foreign Application Priority Data
Jun. 30, 2023 (JP) 2023-108962

(51) Int. Cl. G06T 7/73; G06T 7/00; G06T 7/13; G06T 7/60; H04N 23/72

(52) U.S. Cl. CPC G06T 7/74; G06T 7/0002; G06T 7/13; G06T 7/60; G06T 2207/10024; H04N 23/72

(57) ABSTRACT

A graduation-plate posture inspection method includes an image data acquiring step of acquiring image data on the graduation plate from the camera, a region calculating step of extracting a first contrast region and a second contrast region in the image data, and a contrast processing step of contrasting the first contrast region with the second contrast region based on brightness or color. The contrast processing step includes calculating a difference between pixel values or luminance values of adjacent pixels in each of the first contrast region and the second contrast region to contrast a magnitude of the difference in the first contrast region with a magnitude of the difference in the second contrast region. The relative posture between the camera and the graduation plate is inspected based on a contrast result in the contrast processing step.

### INCORPORATION BY REFERENCE

This application is based upon and claims the benefit of priority from JP patent application No. 2023-108962, filed on Jun. 30, 2023 (DAS code E4C0), the disclosure of which is incorporated herein in its entirety by reference.

### BACKGROUND OF THE INVENTION

### 1. Field of the Invention

The present invention relates to a graduation-plate posture inspection method.

### 2. Description of Related Art

Dial gauges, for example, are measuring devices that display measurement values in analog form. Precision measuring devices such as dial gauges are inspected prior to product shipment or periodically by measuring device manufacturers or inspection agencies to assure measurement accuracy and precise calibration.

Patent Literature 1: JP 2017-067628 A

### SUMMARY OF THE INVENTION

In the inspection of dial gauges, the spindle of a dial gauge to be inspected is displaced by a predetermined amount by a gauge inspection device (master measuring device), and the indication values are compared between the dial gauge to be inspected and the master measuring device to measure the indication error. However, even if a dial gauge is found to have an indication error defect in this inspection method, it has not been possible to distinguish whether the defect is caused by the dial gauge itself or by some problem with the inspection method. If there is a problem with the inspection method, even a measuring device that originally passed the inspection will fail an inspection for defects in the graduation plate or for the accuracy of the measuring device, and this causes problems such as the time and cost for investigating the cause of the problems and replacing parts, that were originally unnecessary.

A purpose of the present invention is to provide a graduation-plate posture inspection method for inspecting a relative posture between a camera and a graduation plate.

A graduation-plate posture inspection method according to an exemplary embodiment of the present invention is a graduation-plate posture inspection method for inspecting a relative posture between a camera and a graduation plate, the method including:
an image data acquiring step of acquiring image data on the graduation plate from the camera;
a region calculating step of extracting a first contrast region and a second contrast region in the image data; and
a contrast processing step of contrasting the first contrast region with the second contrast region based on brightness or color, in which
the relative posture between the camera and the graduation plate is inspected based on a contrast result in the contrast processing step.

In an exemplary embodiment of the present invention, it is preferable that the first contrast region and the second contrast region are positioned on opposite sides of each other with a center of the graduation plate or a virtual straight line passing through the center of the graduation plate between the first contrast region and the second contrast region.

In an exemplary embodiment of the present invention, it is preferable that the first contrast region and the second contrast region each contain a background-colored portion of the graduation plate and a printed or engraved mark.

In an exemplary embodiment of the present invention, it is preferable that the contrast processing step includes calculating a difference between pixel values or luminance values of adjacent pixels in each of the first contrast region and the second contrast region to contrast a magnitude of the difference in the first contrast region with a magnitude of the difference in the second contrast region.

In an exemplary embodiment of the present invention, it is preferable that the graduation-plate posture inspection method further includes:
before the region calculating step is performed,
a brightness adjusting step of adjusting illumination and camera exposure in such a manner that an exposure time of the camera is the longest within a range in which luminance of pixels in the image data is not saturated, and that the number of pixels having brightness above a predetermined threshold is a predetermined fixed count value or more.

In an exemplary embodiment of the present invention, it is preferable that the region calculating step includes:
a center calculating step of calculating a center of the graduation plate, and
the center calculating step includes:
   calculating a line connecting a first pair of graduations at point symmetrical positions with respect to a center between the first pair of graduations, and a line connecting a second pair of graduations at point symmetrical positions with respect to a center between the second pair of graduations; and
   setting an intersection point of the line connecting the first pair of graduations and the line connecting the second pair of graduations as the center of the graduation plate.

In an exemplary embodiment of the present invention, it is preferable that the center calculating step includes:
searching for edge coordinates on one side from one side of each graduation in a width direction using a predetermined algorithm, and edge coordinates on the other side from the other side of the graduation in the width direction using the same algorithm with an orientation different from the predetermined algorithm; and
calculating the line connecting each pair of graduations by setting a midpoint between the edge coordinates on the one side and the edge coordinates on the other side as center coordinates of a width of each graduation and connecting the center coordinates of each pair of graduations.

A graduation-plate posture inspection program according to an exemplary embodiment of the present invention causes a computer to execute:
an image data acquiring step of acquiring image data on a graduation plate from a camera;
a region calculating step of extracting a first contrast region and a second contrast region in the image data; and
a contrast processing step of contrasting the first contrast region with the second contrast region based on brightness or color, in which
a relative posture between the camera and the graduation plate is inspected based on a contrast result in the contrast processing step.

A graduation-plate posture inspection apparatus according to an exemplary embodiment of the present invention is a graduation-plate posture inspection apparatus that inspects a relative posture between a camera and a graduation plate, the apparatus including:
an image data acquisition unit that acquires image data on the graduation plate from the camera;
a region calculation unit that extracts a first contrast region and a second contrast region in the image data; and
a contrast processing unit that contrasts the first contrast region with the second contrast region based on brightness or color, in which
the relative posture between the camera and the graduation plate is inspected based on a contrast result by the contrast processing unit.

In an exemplary embodiment of the present invention, it is preferable that a base plate extending from a stand part that holds a measuring device to be inspected including the graduation plate to be inspected is provided, and
the camera is installed on the base plate.

In an exemplary embodiment of the present invention, it is preferable that the stand part is installed on a master gauge to enable a relative position and posture of the measuring device to be inspected, the master gauge, and the camera to be fixed.

### BRIEF DESCRIPTION OF THE DRAWINGS

FIG. 1 is a system configuration diagram showing a measuring device inspection apparatus;

FIG. 2 is a functional block diagram showing an arithmetic processing device;

FIG. 3 is a block diagram showing a graduation-plate posture inspection unit;

FIG. 4 is a flowchart for explaining an overall procedure of the operation of a graduation-plate posture inspection method;

FIG. 5 is a flowchart for explaining a procedure of a brightness adjusting step;

FIG. 6 is a flowchart for explaining a region calculating step;

FIG. 7 is a flowchart for explaining a procedure for calculating the center of a graduation plate;

FIG. 8 is a flowchart for explaining a procedure for calculating a center coordinate value of a graduation in the width direction;

FIG. 9 is a flowchart for explaining the procedure for calculating the center coordinate value of the graduation in the width direction;

FIG. 10 is a flowchart for explaining a procedure of a contrast region extracting step;

FIG. 11 is a flowchart for explaining a procedure of a contrast processing step;

FIG. 12 is a flowchart for explaining a procedure of a filter processing step;

FIG. 13 is a flowchart for explaining a procedure of an inclination determining step;

FIG. 14 is a diagram showing an example of the procedure for calculating the center of the graduation plate;

FIG. 15 is an enlarged view of a graduation;

FIG. 16 is a diagram showing examples of a first contrast region and a second contrast region;

FIG. 17 is a diagram schematically showing a change in luminance difference when a one-dimensional differential filter is applied along a graduation longitudinally-crossing line;

FIG. 18 is a diagram showing an example of a guidance display; and

FIG. 19 is a diagram showing an example of the guidance display.

### DETAILED DESCRIPTION

An embodiment of the present invention is illustrated and described with reference to the reference signs assigned to the elements in the drawings.

### First Exemplary Embodiment

A measuring device inspection apparatus according to a first exemplary embodiment of the present invention is described below.

A measuring device inspection apparatus 100 inspects a measuring device 10 that displays a measurement value in analog form with, for example, a disk-shaped graduation plate 200 and a rotating pointer, such as a (analog display type) dial gauge. (Dial gauges can be referred to as indicators or test indicators.)

The precision measuring device 10, such as a dial gauge, is periodically inspected by measuring device manufacturers or inspection agencies to assure measurement accuracy and precise calibration. The measuring device inspection apparatus 100 according to the present exemplary embodiment inspects whether the installation posture of the measuring device inspection apparatus 100 and the measuring device 10 is appropriate (performs a graduation-plate posture inspection) before inspecting the measuring device 10 itself (performing a defect inspection or an indication value error inspection of disk-shaped graduation plate 200).

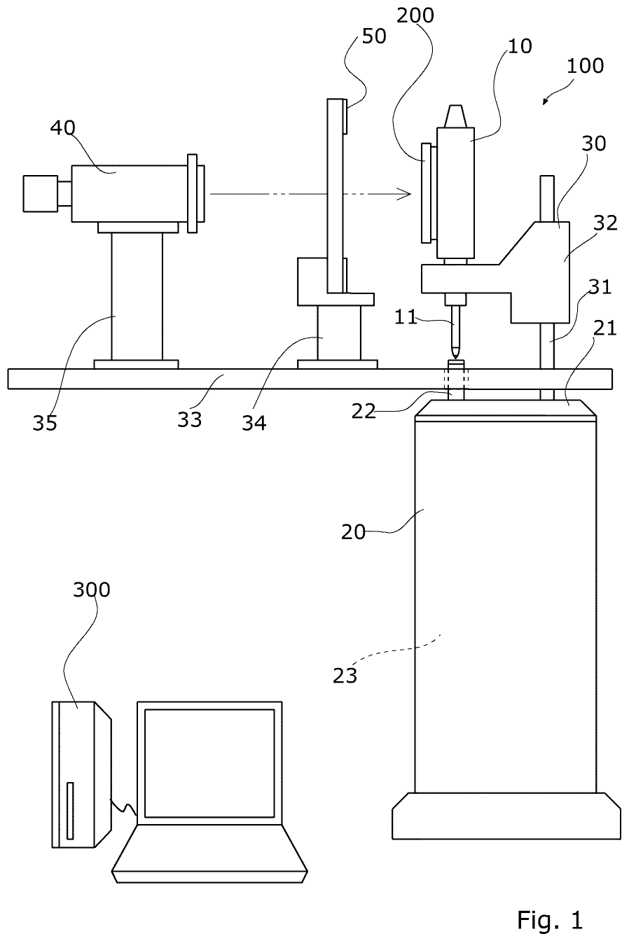

FIG. 1 is a system configuration diagram showing the measuring device inspection apparatus 100.

The measuring device inspection apparatus 100 includes a master gauge 20 that serves as a reference for measuring device indication values, a stand part 30 for installing the measuring device 10 to be inspected on the master gauge 20, a camera 40 that images an analog display unit 200 of the measuring device 10 to be inspected, an illumination unit 50 that illuminates the analog display unit 200 of the measuring device 10 to be inspected, and an arithmetic processing device 300.

The master gauge 20 includes a reference spindle 22 that moves forward and backward, and a precisely calibrated high-precision encoder (displacement detector) 23. The reference spindle 22 displaces a contact point 11 of the measuring device 10 to be inspected, and the high-precision encoder 23 detects the displacement of the reference spindle 22. The difference between the indication value of the master gauge 20 (the detection value of the high-precision encoder 23) and the indication value of the measuring device 10 to be inspected is the error of the measuring device 10 to be inspected.

In the present exemplary embodiment, the measuring device inspection apparatus 100 includes the master gauge 20 on the assumption that an indication value error inspection is to be performed following a graduation plate-posture inspection and a graduation-plate defect inspection. However, if the graduation-plate defect inspection is performed only as the inspection of the measuring device 10 and the indication value error inspection using the master gauge 20 is not performed, the master gauge 20 is not necessary. That is, the master gauge 20 is an additional element in the present invention and is not essential.

The stand part 30 includes a column 31 and a bracket part 32. The column 31 is installed on a lid part 21 of the master gauge 20, and the bracket part 32 is provided to be movable along the column 31. The bracket part 32 includes an arm part extending orthogonally to the column 31 and holds the measuring device 10 to be inspected at the tip of the arm part. Specifically, a part of the measuring device 10 to be inspected (in FIG. 1, the stem of the dial gauge) is held at the tip of the bracket part 32.

When the master gauge 20 is not used, what is called a stand including the column 31 provided in a standing manner on a base is prepared, and the stand (base) is installed on a workbench or the like.

The camera 40 includes a lens optical system and an image sensor, such as a CCD or CMOS. The camera 40 is installed so as to image the graduation plate 200 of the measuring device 10 to be inspected from the front. That is, the camera 40 is installed so as to image the graduation plate 200 of the measuring device 10 to be inspected held by the stand part 30 from the front. In the present exemplary embodiment, the camera 40 is fixedly installed, and the relative posture and relative position between the camera 40 and the measuring device 10 to be inspected are assumed to be adjusted by adjusting the orientation (inclination) and position of the measuring device 10 to be inspected. Since the final goal is to adjust the posture in such a manner that the camera 40 and the measuring device 10 to be inspected (graduation plate 200) face each other, the orientation (inclination) and position of the camera 40 may also be adjustable.

Here, the camera 40 and the measuring device 10 (graduation plate 200) ideally facing each other means that the graduation plate 200 is orthogonal to the optical axis of the camera 40, considering the surface of the graduation plate 200 as a plane. It can also be said that the normal of the graduation plate 200 and the optical axis of the camera 40 are parallel.

The illumination unit 50 is, for example, a ring illumination and illuminates the graduation plate 200 of the measuring device 10 to be inspected in such a manner that uneven luminance due to shadows does not occur.

In the present exemplary embodiment, a long plate-shaped base plate 33 is attached to the column 31 of the stand part 30, and the camera 40 and the illumination unit 50 are installed on the base plate 33. That is, an illumination installation stand 34 and a camera installation stand 35 are provided on the base plate 33 to fixedly install the illumination unit 50 and the camera 40 with respect to the stand part 30 holding the measuring device 10 to be inspected. Preferably, the illumination installation stand 34 and the camera installation stand 35 can move back and forth or left and right to the extent that their positions can be adjusted with respect to the base plate 33, and their positions can be fixed with set screws or the like.

When the stand part 30 is installed on the master gauge 20, the relative position and posture between the master gauge 20, the measuring device 10 to be inspected, the illumination unit 50, and the camera 40 can be fixed. In inspecting the accuracy of the measuring device 10 to be inspected, the accuracy can be inspected in different postures, such as vertical, horizontal, and reverse postures. In this case, the master gauge 20 and the measuring device 10 to be inspected are inclined to be in a horizontal posture, rotated to be in a reverse posture, or changed to various other postures, in which case the illumination unit 50 and the camera 40 are moved together with the master gauge 20, the stand part 30, and the measuring device 10 to be inspected. Therefore, once the brightness and posture are adjusted, there is no need to readjust them even if the inspection posture is changed.

In the present exemplary embodiment, it is assumed that the base plate 33 is attached at a right angle to the column 31, the camera installation stand 35 is attached at a right angle to the base plate 33, and the camera 40 is attached at a right angle to the camera installation stand 35. Thus, when the measuring device 10 to be inspected (for example, a dial gauge) is attached to the stand part 30, the vertical axis of the measuring device 10 to be inspected (the axis parallel to the spindle and the stem) is orthogonal to the optical axis of the camera 40. In the present exemplary embodiment, the inclination in the left-right direction (rotation using the axis parallel to the spindle and the stem as the rotation axis) is to be checked. The method in the present exemplary embodiment can also be applied to the vertical direction to correct the inclination in the vertical and horizontal directions.

The arithmetic processing device 300 is typically a small computer with a keyboard, a mouse, a microphone, a display, a printer, and a speaker built into or external to the computer body as input/output devices. Alternatively, the arithmetic processing device 300 may be a tablet device or a smart phone (portable high-performance phone).

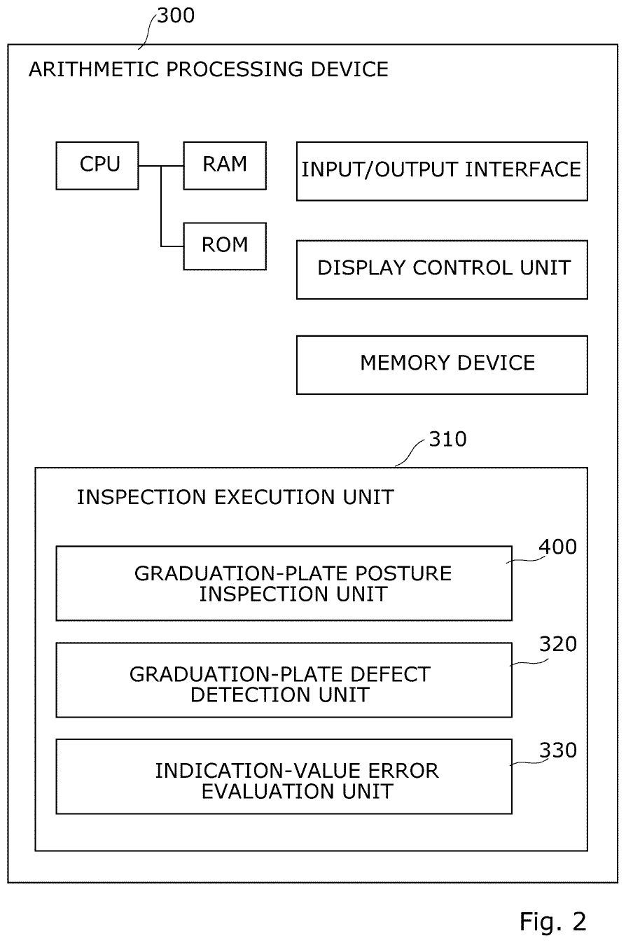

FIG. 2 is a functional block diagram showing the arithmetic processing device 300.

The arithmetic processing device 300 includes a central processing unit (CPU), a memory (ROM, RAM), and the like, and performs functions of functional units by the CPU executing an inspection program. The inspection program may be distributed by being recorded on a non-volatile recording medium (a CD-ROM, a memory card, or the like) or by being downloaded via an Internet connection or the like.

The arithmetic processing device 300 includes an inspection execution unit 310 that executes various inspections of the measuring device 10. The inspection execution unit 310 includes a graduation-plate posture inspection unit 400, a graduation-plate defect detection unit 320, and an indication-value error evaluation unit 330.

Here, the graduation-plate posture inspection unit 400 inspects the relative posture between the camera 40 and the graduation plate 200 from the image data on the graduation plate 200 imaged by the camera 40. The details thereof are described later.

The graduation-plate defect detection unit 320 detects defects, such as distortion, scratches, missing graduations, and graduations intervals on the graduation plate 200, from the image data on the graduation plate 200 imaged by the camera 40.

At this time, if the graduation plate 200 is inclined with respect to the camera 40, the graduation plate 200 or the graduations cannot be accurately inspected based on the image data. That is, even if there is a defect in the graduation plate 200 or the graduations in the image data, it is necessary to distinguish whether the defect is in the measuring device to be inspected itself or whether the image data is originally distorted. The indication-value error evaluation unit 330 evaluates the discrepancy between the indication value of the master gauge 20 (detection value of the high-precision encoder 23) and the indication value of the measuring device 10 to be inspected. At this time, it is assumed that the analog display unit 200 of the measuring device 10 to be inspected is imaged by the camera 40 and the indication value is automatically read from the imaged data. In this case, if the graduation plate 200 is inclined with respect to the camera 40, the image data has a parallax for the amount of inclination, and the reading of the indication value of the pointer will have a discrepancy. If there is a discrepancy between the indication value of the pointer of the measuring device 10 to be inspected and the indication value of the master gauge 20, it is necessary to distinguish whether the discrepancy is due to a defect in the internal mechanism of the measuring device 10 to be inspected or a problem of a parallax at the time of image data acquisition.

Since the measuring device 10 to be inspected displays a measurement value with micrometer-order resolution, when the relative posture between the camera 40 and the measuring device 10 to be inspected deviates about 5° from the facing posture, this will interfere with the graduation-plate defect detection or the indication-value error evaluation, and it is considered ideal to keep the deviation of the relative posture between the camera 40 and the measuring device 10 to be inspected within 3°, according to the verification of the inventors. Such a deviation of 3° or 5° is not noticeable to the human eye. For this reason, before the graduation-plate defect detection or indication-value error evaluation, a graduation-plate posture inspection step is performed.

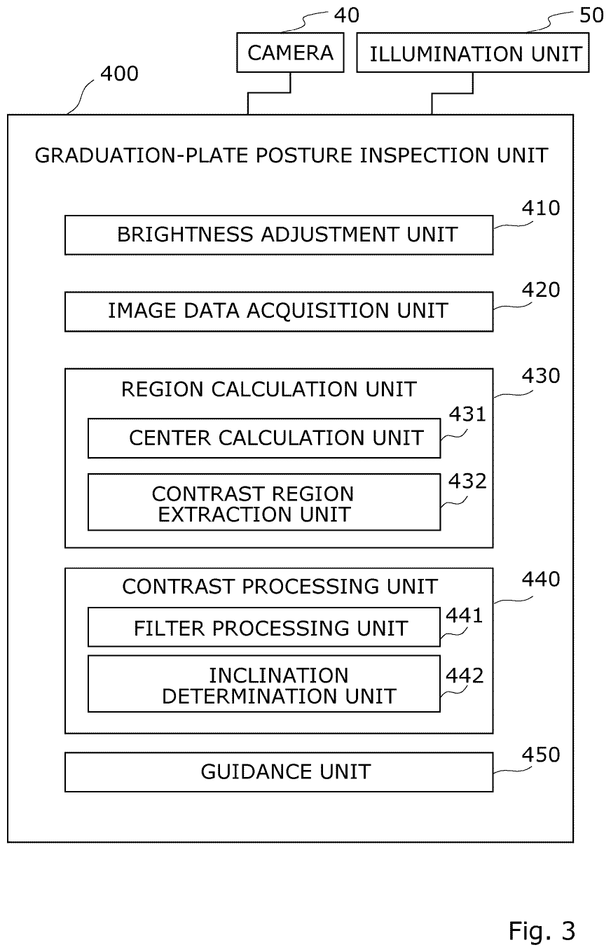

FIG. 3 is a block diagram showing the graduation-plate posture inspection unit 400.

The graduation-plate posture inspection unit 400 includes a brightness adjustment unit 410, an image data acquisition unit 420, a region calculation unit 430, a contrast processing unit 440, and a guidance unit 450. The region calculation unit 430 includes a center calculation unit 431 and a contrast region extraction unit 432. The contrast processing unit 440 includes a filter processing unit 441 and an inclination determination unit 442.

The operation of each functional unit is described later with reference to a flowchart.

A procedure of a graduation-plate posture inspection method according to the first exemplary embodiment is described in order. Before performing the graduation-plate posture inspection method, an operator installs the measuring device 10 to be inspected on the stand part 30 and adjusts the measuring device 10 to be inspected and the camera 40 in such a manner that they face each other as much as possible. The camera 40 may be focused on the graduation plate 200 of the measuring device 10 to be inspected, the illumination and exposure may be set to preset default settings, and the automatic adjustment (automatic focusing and exposure adjustment) of the camera 40 may be activated as an initial adjustment. The installation (replacement) of the measuring device 10 to be inspected on the stand part 30 and the setting up of the camera 40 may be automated by a robot, instead of manual work by the operator.

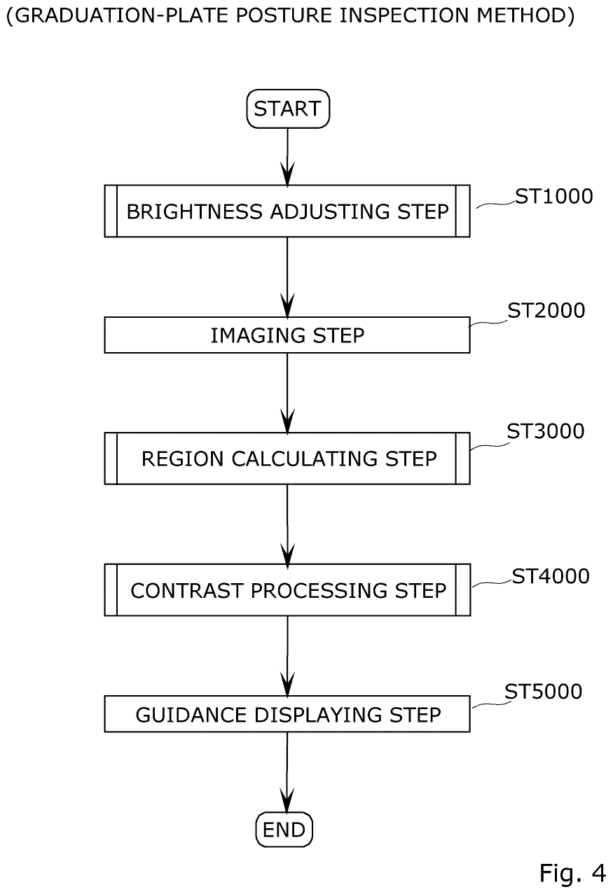

FIG. 4 is a flowchart for explaining an overall procedure of the operation of the graduation-plate posture inspection method according to the first exemplary embodiment.

As shown in FIG. 4, the graduation-plate posture inspection method includes a brightness adjusting step ST1000, an imaging step ST2000, a region calculating step ST3000, a contrast processing step ST4000, and a guidance displaying step ST5000.

The steps are described below in order.

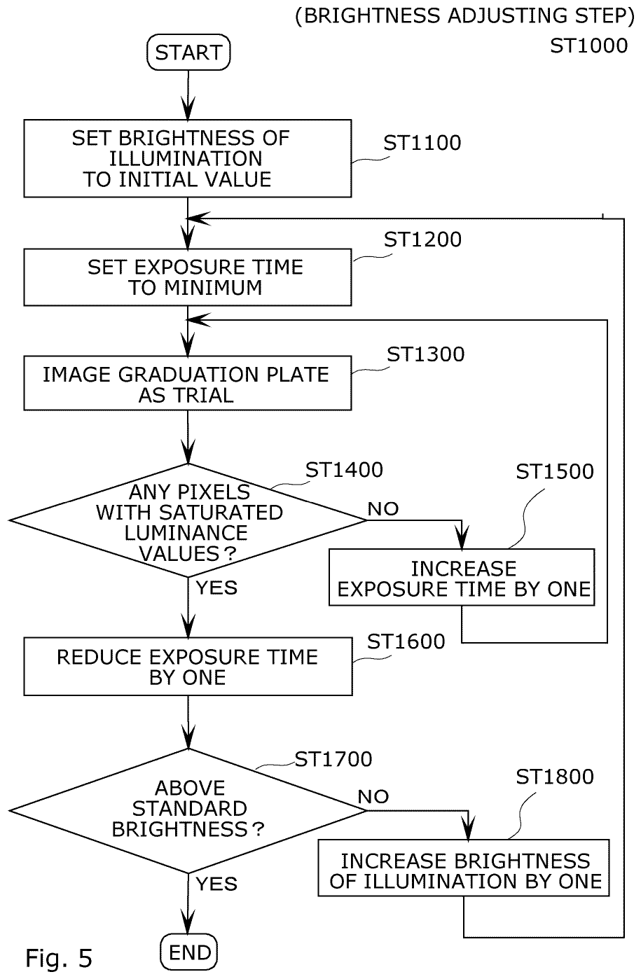

FIG. 5 is a flowchart for explaining a procedure of the brightness adjusting step ST1000.

Considering the subsequent steps, it is desirable that the image data on the graduation plate 200 uses the widest possible range of luminance. Therefore, the illumination and exposure are adjusted in such a manner that the image data is brightened to the limit within a range in which luminance of the pixels in the image data is not saturated.

First, the brightness of the illumination unit 50 is set to a predetermined initial value (ST1100), and the exposure time of the camera 40 is set to minimum (ST1200). Minimizing the exposure time of the camera 40 means minimizing the exposure time within the specifications of the camera 40, in other words, setting the shutter speed to the fastest possible speed. Setting the brightness of the illumination unit 50 to the initial value may be considered as, for example, setting the current or voltage value to be applied to the illumination unit 50 to a predetermined initial value. Alternatively, an illuminometer may be placed near the measuring device 10 to be inspected, and the current value (voltage value) applied to the illumination unit 50 may be automatically adjusted to achieve preset illuminance. With this setting, the graduation plate 200 of the measuring device 10 to be inspected is imaged as a trial to acquire image data (ST1300). The acquired image data is recorded in the image data acquisition unit 420.

In the trial image data, it is checked whether there are any pixels with saturated luminance values (ST1400). When there are no pixels with saturated luminance values (ST1400: NO), the exposure time of the camera 40 is increased by one unit (ST1500). One unit of exposure time of the camera 40 is set appropriately in a unit of 1/1000 second, 1/100 second, or 1/10 second, taking into consideration the specifications of the camera 40, the inspection accuracy of the graduation plate 200, and the time required for the inspection. Here, since the exposure of the camera 40 is set to minimum, the luminance is not saturated from the beginning, and the imaging is repeated as a trial (ST1300) while the exposure time of the camera 40 (ST1500) is increased until the first pixel with a saturated luminance value appears (ST1400).

When the first pixel with a saturated luminance value appears (ST1400: YES), the exposure time is reduced by one unit from the exposure time at that point (ST1600). This means that the exposure time is now set to the maximum exposure time within the range in which the luminance of the pixels in the image data is not saturated.

With this illumination and exposure time setting, it is checked whether the image data is above a predetermined standard brightness (ST1700). The luminance distribution (histogram) of the image data is calculated, and the number of pixels with brightness (luminance value) above a predetermined threshold is counted. When the count value exceeds a predetermined number, the brightness adjustment is assumed to be successful. When the number of pixels with brightness (luminance value) above the predetermined threshold is not sufficient, the brightness of the illumination unit 50 is increased by one unit (the current value to be applied or illumination intensity is increased) (ST1800), and the procedure returns to ST1200 to perform the brightness adjustment again.

This brightness adjustment ensures that the luminance distribution of the image data is optimal each time and that the posture inspection is stable each time.

When the brightness adjustment is successful (ST1000), the procedure returns to the flowchart in FIG. 4, and the graduation plate 200 is imaged by the camera 40 (image sensor) to acquire image data (ST2000) and record the image data in the image data acquisition unit 420 as image data for inspection.

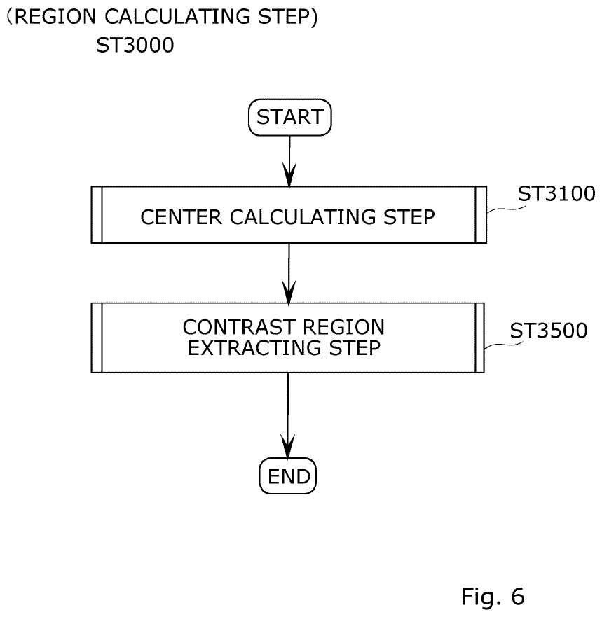

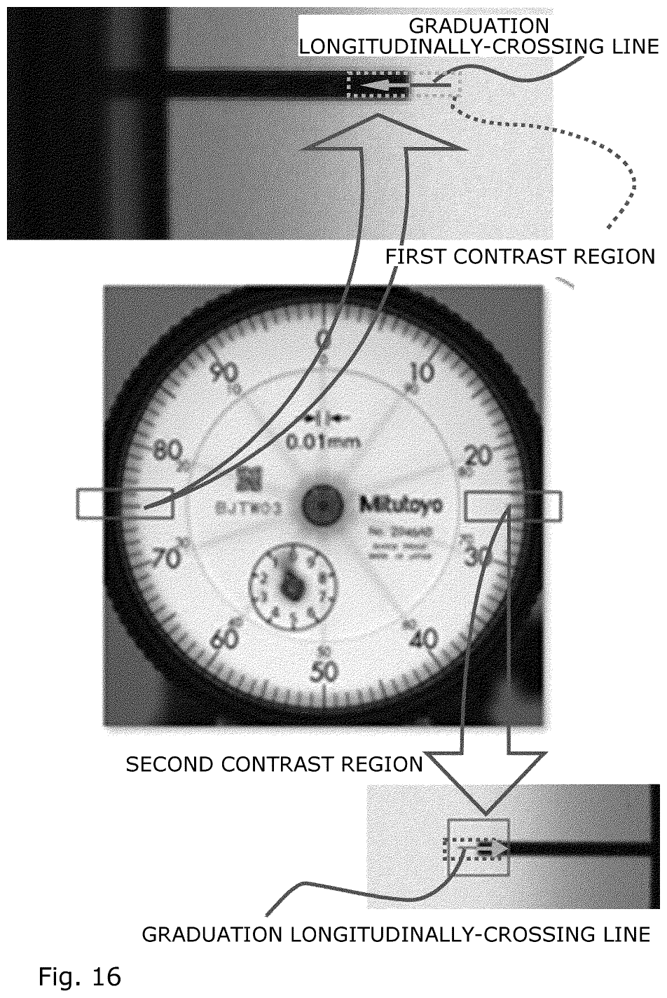

Since graduation plate image data for inspection has been acquired, the relative posture between the graduation plate 200 and the camera 40 is inspected based on the graduation plate image data. For the inspection, a contrast region extracting step (ST3500 in FIG. 6) is performed to extract a first contrast region and a second contrast region to be contrasted in the image data. The first contrast region and the second contrast region are regions in the image data that are in a point symmetry relationship with the center of the graduation plate 200 as the center of symmetry, or are regions positioned on opposite sides of each other with a virtual straight line passing through the center of the graduation plate 200 therebetween, as shown in FIG. 16. By contrasting the pixel value (color and luminance) in the first contrast region with that in the second contrast region, the relative posture of the camera 40 and the graduation plate 200 is checked.

FIG. 6 is a flowchart for explaining a procedure for extracting the contrast regions (the region calculating step ST3000).

In the calculation of the contrast regions (region calculating step ST3000), the center of the graduation plate 200 in the image data is first calculated (a center calculating step ST3100). There are various methods for calculating the center of the graduation plate 200. For example, by considering the graduation plate 200 in the image data as a circle, the center of the circle may be calculated. In addition, the outer shape of the graduation plate (circle) 200 may be extracted by image recognition to calculate the center of the circle from several points on the circumference. If the graduation plate 200 is inclined with respect to the camera 40, the graduation plate 200 is, strictly speaking, imaged as an ellipse, but this distortion is very slight, and the center may be calculated by considering the ellipse as a circle. Even if the graduation plate 200 is considered as an ellipse, the center can be calculated from the intersection point of the major diameter and the minor diameter.

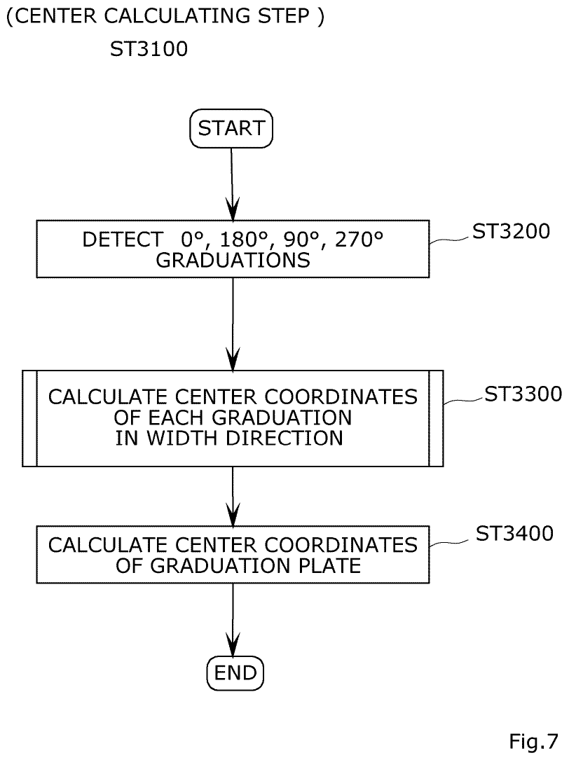

Here, taking into consideration that the graduations of the graduation plate 200 is one of the important elements in the subsequent graduation-plate defect detection and indication-value error evaluation, the center of the graduation plate 200 is calculated based on the graduations with a procedure (the center calculating step ST3100) in the flowchart in FIG. 7.

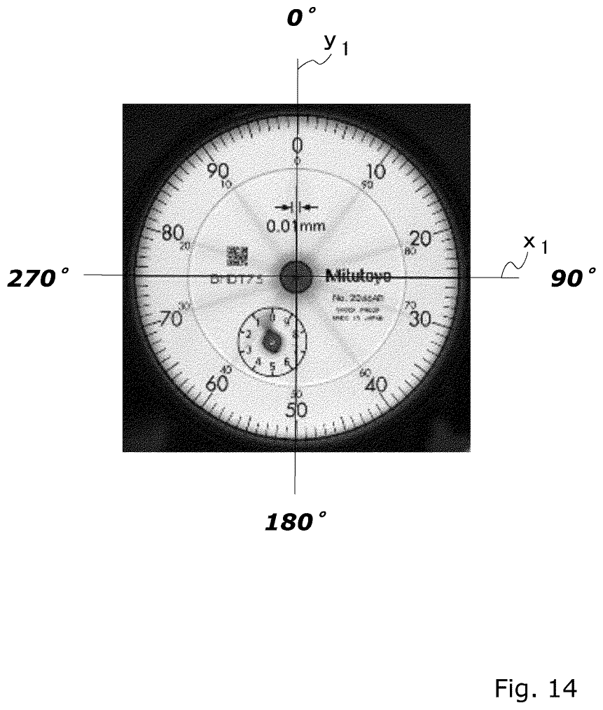

FIG. 14 is a diagram showing an example of the center of the graduation plate 200, and is also referred to.

By detecting two graduations parallel to the y-axis from the graduation plate image data in two-dimensional Cartesian coordinates (x, y), a 0° graduation and a 180° graduation are found (ST3200) (see FIG. 14). In addition, by detecting two graduations parallel to the x-axis from the graduation plate image data in two-dimensional Cartesian coordinates (x, y), a 90° graduation and a 270° graduation are found (ST3200). Then, the center coordinates of the 0° graduation in the width direction are calculated, and the center coordinates of the 180° graduation in the width direction are calculated (ST3300). Similarly, the center coordinates of the 90° graduation in the width direction are calculated, and the center coordinates of the 270° graduation in the width direction are calculated (ST3300).

Once the center coordinates of each graduation in the width direction are calculated, the center coordinates of the 0° graduation and the center coordinates of the 180° graduation are connected to form a y1 line. Similarly, the center coordinates of the 90° graduation and the center coordinates of the 270° graduation are connected to form an x1 line. The intersection point of the y1 line and the x1 line is set as the center of the graduation plate 200 (ST3400).

However, since the graduations each has a width, the coordinate value of the center of the width of each graduation is used as the position of the graduation (ST3300). At this time, when, for example, the center of the width of the graduation at 0° is set, the midpoint of the coordinate value of the left edge of the graduation and the coordinate value of the right edge of the graduation is used. In order to prevent the midpoint coordinates from being shifted to either the left or right side within the width of the graduation, the left edge and the right edge are searched for using the same procedure and the same threshold.

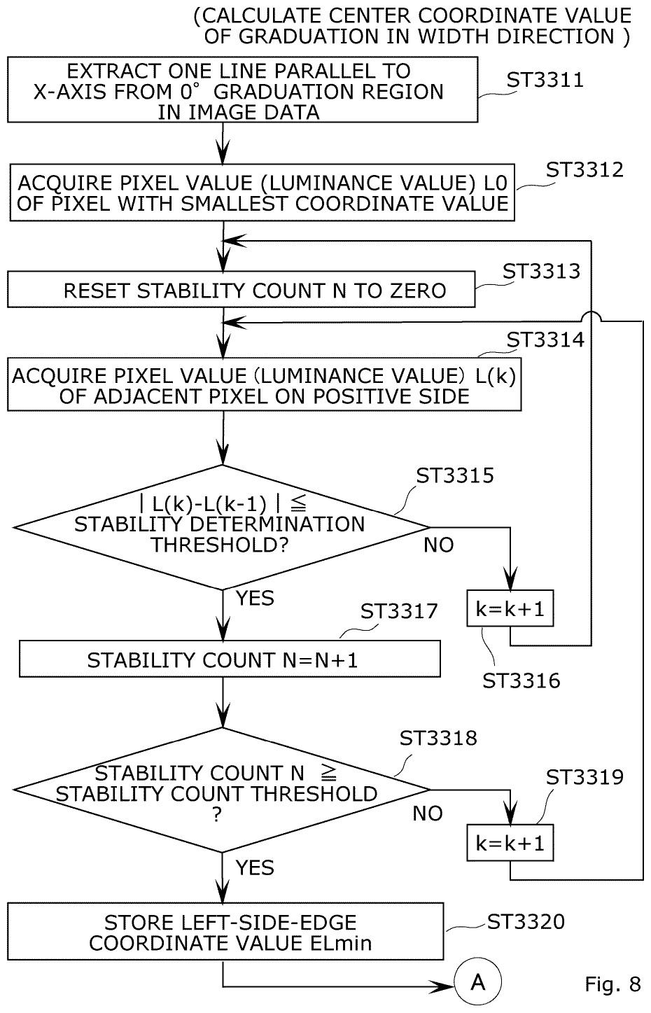

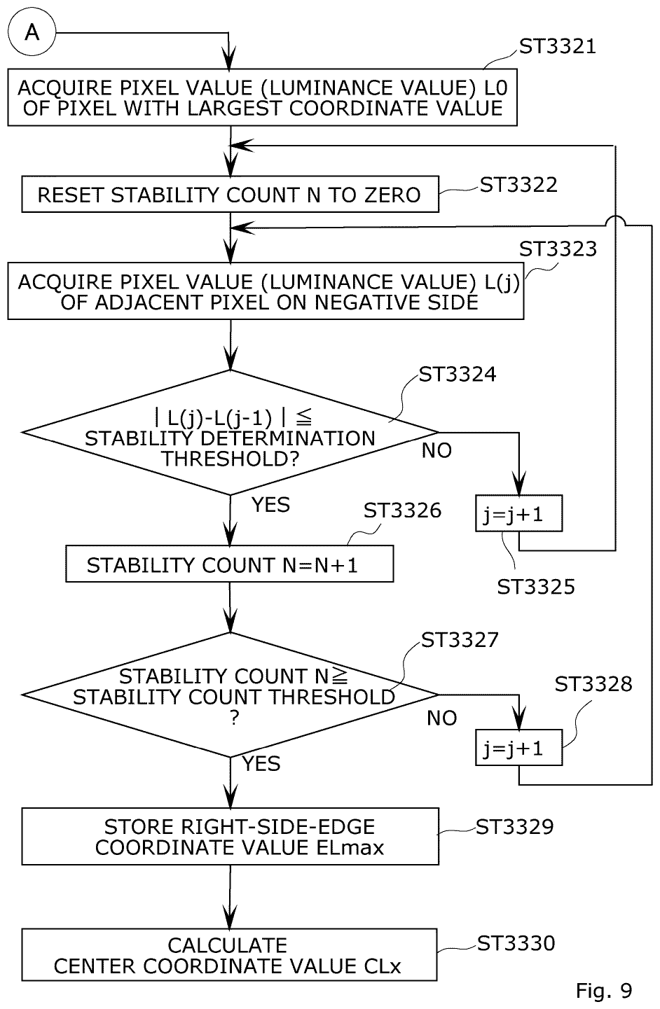

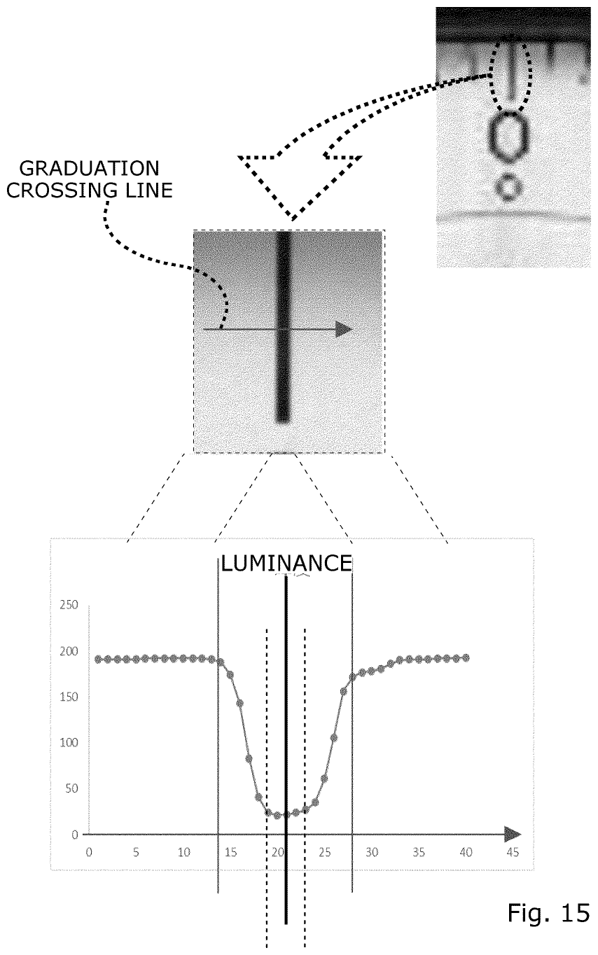

FIGS. 8 and 9 are flowcharts for explaining a procedure for calculating the center coordinate value of a graduation in the width direction. Here, the case of calculating the center coordinate value of the 0° graduation in the width direction is described as an example. FIG. 15 is an enlarged view of the graduation, and is also referred to. The same procedure can be applied to the case of calculating the center of the width of the graduation at 180°. In addition, by changing the orientation (exchanging the x-axis with the y-axis), the same procedure can also be applied to the case of calculating the center of the width of the graduation at each of 90° and 270°.

In ST3311, one line parallel to the X-axis is extracted from a region of the 0° graduation. The graduation parallel to the Y-axis and on the positive side of the Y-axis (or the graduation with the larger Y coordinate value) is recognized as the 0° graduation. Since the background is white and the graduation is black, the region of pixels with luminance less than half (128) of the maximum luminance (255) may be set as a graduation region, for example. Alternatively, the region of pixels with luminance less than 0.7 (179) of the maximum luminance (255) may be set as the graduation region, or the region of pixels with luminance less than 0.65 (166) may be set as the graduation region. Here, the graduation region contains both the graduation itself and the background around the graduation. In other words, the graduation region is defined as the region in which a graduation crossing line, which will be described later, can cross from the background to the graduation to the background.

Then, in order to calculate the center coordinate value of the width of the graduation (here, the width in the X direction), one line that crosses the graduation region in a direction (parallel to the X direction) orthogonal to the graduation parallel to the Y direction is extracted. This line is referred to as the graduation crossing line. In FIG. 15, the graduation crossing line is shown as a long line for clarity.

The graduation crossing line is only required to certainly cross the graduation, and there is no particular limitation on where on the graduation the line crosses (which line is extracted). Here, as an example, a line crossing the middle of the graduation region in the Y direction (the middle of the graduation in the vertical direction) is extracted.

For the graduation crossing line extracted in this manner, the same algorithm with different orientations is used to search for the left edge coordinates (the coordinates of the edge in the direction in which the X coordinate value is small) and the right edge coordinates (the coordinates of the edge in the direction in which the X coordinate value is large). First, the left side edge coordinates (the coordinates of the edge in the direction in which the X coordinate value is small) are searched for in ST3312 to ST3320 in FIG. 8.

In ST3312, the pixel with the smallest X coordinate value in the graduation crossing line is set as the pixel of interest, and the luminance value of this pixel of interest is acquired. The acquired luminance value is represented as L0.

In ST3313, a stability count N is reset to 0 (zero). The stability count N is described later.

In ST3314, the pixel of interest is moved one pixel to the positive side in the X direction (adjacent pixel on the positive side), and the luminance value of this new pixel of interest is acquired, which is represented as L(k) using an index number k. Here, the new pixel of interest is represented as L1. In ST3315, the luminance difference L(k)−L(k−1), specifically L1−L0, between two adjacent pixels in the X direction is calculated, and the magnitude of the luminance difference |L1−L0| is compared with a preset stability determination threshold to determine whether the luminance difference |L1−L0|≤stability determination threshold is satisfied. Satisfying the luminance difference |L1−L0|≤stability determination threshold infers that the pixel of interest is not on the transitional boundary between the background and the graduation, but is on or inside the graduation. When the luminance difference |L1−L0|≤stability determination threshold is satisfied, the stability count N is increased by 1 (N=N +1) (ST3317). Until the stability count N reaches a preset stability count threshold (for example, 5) (ST3318), ST3314 to ST3318 are repeated while the pixel of interest is moved in the positive direction of the X direction (ST3319, ST3314). When the luminance difference L(k)−L(k−1) of adjacent pixels is continuously stable and the number of stability counts N reaches the stability count threshold (for example, 5), the coordinate value of the pixel of interest at that time (here, the X coordinate value) is stored as left side edge coordinates ELmin.

Not satisfying the luminance difference |L1−L0|≤the stability determination threshold (ST3315: NO) infers that the pixel of interest is on the transitional boundary between the background and the graduation and not on the graduation, thus the stability count is reset to zero (ST3313) and the search is continued.

In FIG. 9, ST3321 to ST3329 are the procedure for searching for the right edge coordinates (the coordinate of the edge in the direction in which the X coordinate value is large).

The difference from ST3312 to ST3320 in FIG. 8 is that the search is performed from right to left (from a larger X coordinate value to a smaller X coordinate value). First, in ST3312, the pixel with the largest X coordinate value in the graduation crossing line is set to the pixel of interest, and the luminance value L0 of this pixel of interest is acquired (ST3321). Then, in ST3323, the luminance value L(j) of the adjacent pixel on the negative side is acquired. In the search for the right edge coordinates (the flowchart in FIG. 9), an index number j is used. In the other procedures, both the stability determination threshold and the stability count threshold are the same as in ST3312 to ST3320 in FIG. 8. The same algorithm with different orientation is used to search for the right edge coordinates, and the right edge coordinates searched for is stored as right edge coordinates ELmax (ST3329).

The center coordinate value CLx of the graduation is the midpoint between the left edge coordinates ELmin and the right edge coordinates ELmax, that is (Elmin+ELmax)/2 (ST3330).

In this manner, by searching for the edges from both the left and right sides using the same procedure, any deviation in the midpoint detection within the width of the graduation is eliminated.

Alternatively, two or more graduation crossing lines may be extracted, and the center coordinate values of these lines in the width direction may be calculated to determine the average value.

The center of the graduation plate 200 has been calculated at this point (ST3100), and the contrast region extracting step (ST3500) is described, returning to the flowchart in FIG. 6 (the region calculating step ST3000).

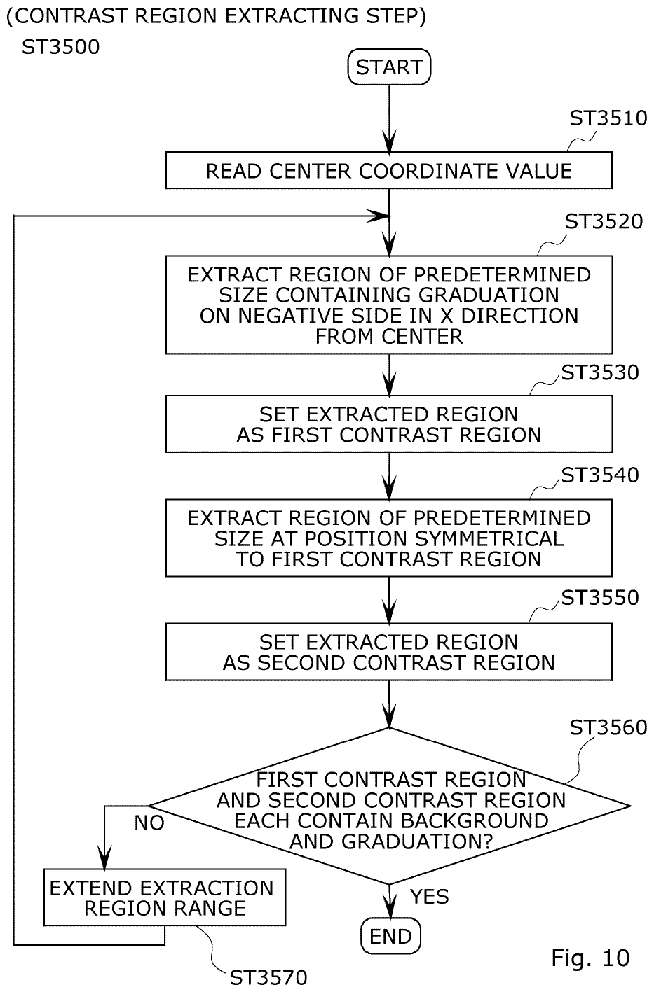

FIG. 10 is a flowchart for explaining a procedure of the contrast region extracting step (ST3500). FIG. 16 is a diagram showing an example of the first contrast region and the second contrast region, is also referred to. In ST3510, the center coordinate value of the graduation plate 200 previously calculated is read. Then, a region of a predetermined size that contains the graduation on the negative side in the X direction from the center is extracted (ST3520). (The region is searched for to the negative side along the line parallel to the X axis and passing through the center to find the 270° graduation.) This region is set as the first contrast region (ST3530). Here, the region including the graduation at 270° is the first contrast region. As this contrast region, the region that is assumed to contain both the graduation and the background is extracted.

Next, a region of the predetermined size is extracted at a position symmetrical to the first contrast region (ST3540). This region is set as the second contrast region (ST3550). Here, the first contrast region and the second contrast region are assumed to be point-symmetrical with respect to the center, but may also be line-symmetrical with respect to a virtual line parallel to the Y-axis and passing through the center.

It is checked whether the first contrast region and the second contrast region each contain the background and the graduation (ST3560). Since the graduation plate 200 is circular, the two graduations are positioned symmetrically with respect to the center, and the first contrast region and the second contrast region each contain the graduation and the background as long as the second contrast region is extracted symmetrically with respect to the first contrast region. If at least one of the first contrast region and the second contrast region does not contain both the graduation and the background (ST3560: NO), extraction is retried by extending the extraction region range (ST3570). If the first contrast region and the second contrast region are not successfully extracted after a predetermined number of retries, an error notification is performed, and the procedure is suspended.

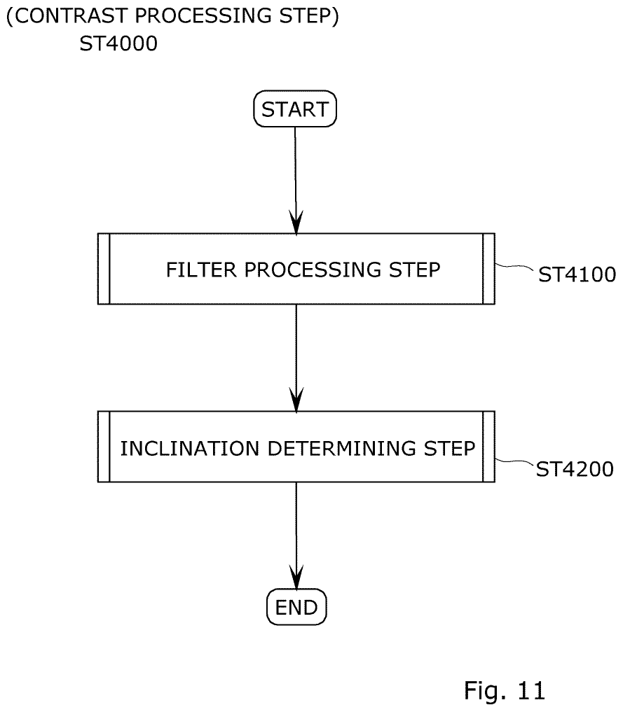

After the first contrast region and the second contrast region are extracted, the contrast processing step (ST4000) of contrasting the first contrast region with the second contrast region based on luminance is performed, returning to the flowchart in FIG. 4 (the graduation-plate posture inspection method). FIG. 11 is a flowchart showing a procedure of the contrast processing step (ST4000). The contrast processing step (ST4000) includes a filter processing step (ST4100) of performing filter processing (differential filter in this case) on the first contrast region and the second contrast region to obtain the luminance difference in each contrast region, and an inclination determining step (ST4200) of comparing the luminance difference data obtained in the filter processing step (ST4100) to evaluate the inclination of the graduation plate 200.

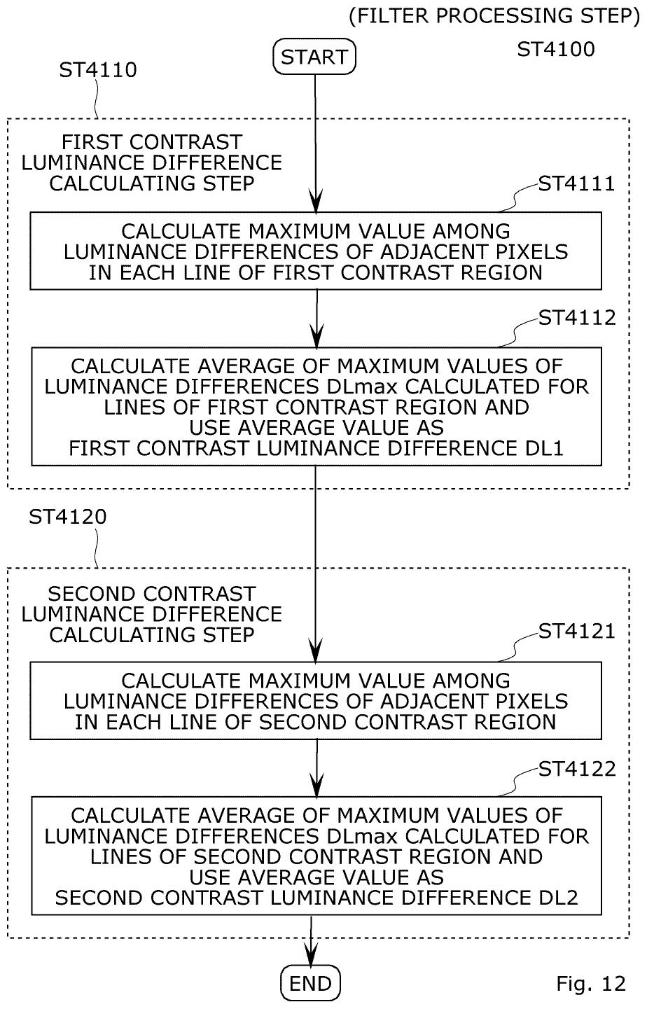

FIG. 12 is a flowchart for explaining a procedure of the filter processing step. The filter processing step ST4100 includes a first contrast luminance difference calculating step (ST4110) of performing filter processing on the first contrast region to obtain a first contrast luminance difference, and a second contrast luminance difference calculating step (ST4120) of performing filter processing on the second contrast region to obtain a second contrast luminance difference. The first contrast luminance difference calculating step (ST4110) and the second contrast luminance difference calculating step (ST4120) have different calculation targets but the same processing content.

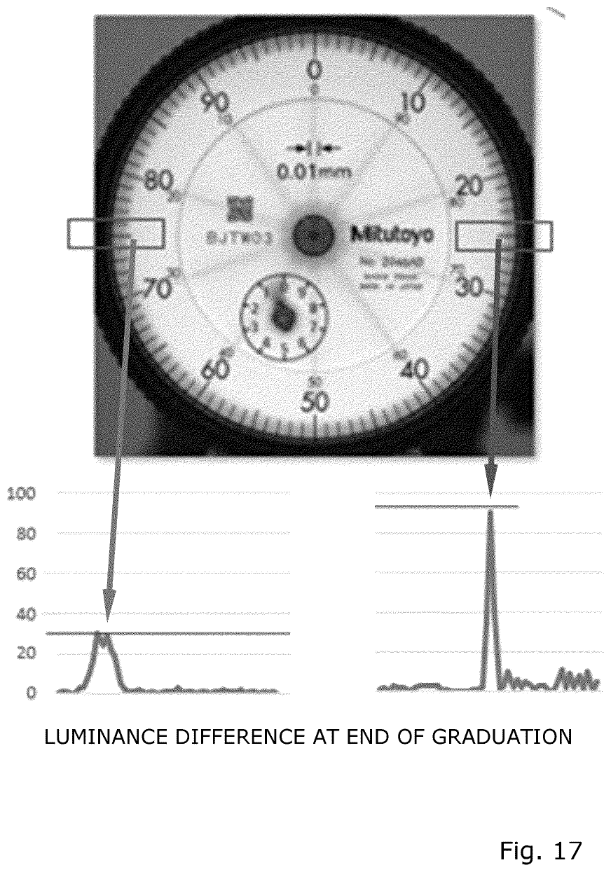

In the first contrast luminance difference calculating step (ST4110), the maximum value among the luminance differences of respective adjacent pixels in each line of the first contrast region is first calculated (ST4111). Here, since the first contrast region is the region containing the 270° graduation, and the 270° graduation is parallel to the X axis, a line longitudinally-crossing the graduation along the X direction is referred to as a graduation longitudinally-crossing line. FIG. 16 is also referred to. A one-dimensional differential filter is applied to each graduation longitudinally-crossing line, for example, the pixel value (luminance value) of each pixel is multiplied by (1, −1) along the X direction to calculate the difference in luminance between the pixel of interest and its adjacent pixel. FIG. 17 is a diagram schematically showing the change in luminance difference when the one-dimensional differential filter is applied along the graduation longitudinally-crossing line, and is also referred to. For example, when the luminance value of the pixel of interest is L1 and the luminance value of its adjacent pixel is L2, the luminance difference DL is |L1−L2|. Eventually, it is sufficient to contrast the “magnitude” of the luminance difference obtained in the first contrast region with that in the second contrast region, and the luminance difference here is regarded as the magnitude (absolute value) of the luminance difference. For each line (each graduation longitudinally-crossing line), a maximum value of luminance difference DLmax is calculated.

In calculating the maximum value of luminance difference DLmax in the first contrast luminance difference calculating step (ST4110), only one line (graduation longitudinally-crossing line) may be used for the calculation, but it is desirable to calculate the maximum value of luminance difference DLmax for each of multiple lines (graduation longitudinally-crossing lines). Then, in ST4112, the average of the calculated multiple maximum values of luminance differences DLmax is calculated to be used as a first contrast luminance difference DL1 (ST4112).

For the second contrast region (in this case, the region containing the 90° graduation), the maximum value DLmax among the luminance differences of respective adjacent pixels in each line is also calculated (ST4121), and the average of the maximum values DLmax is calculated to be used as a second contrast luminance difference DL2 (ST4122).

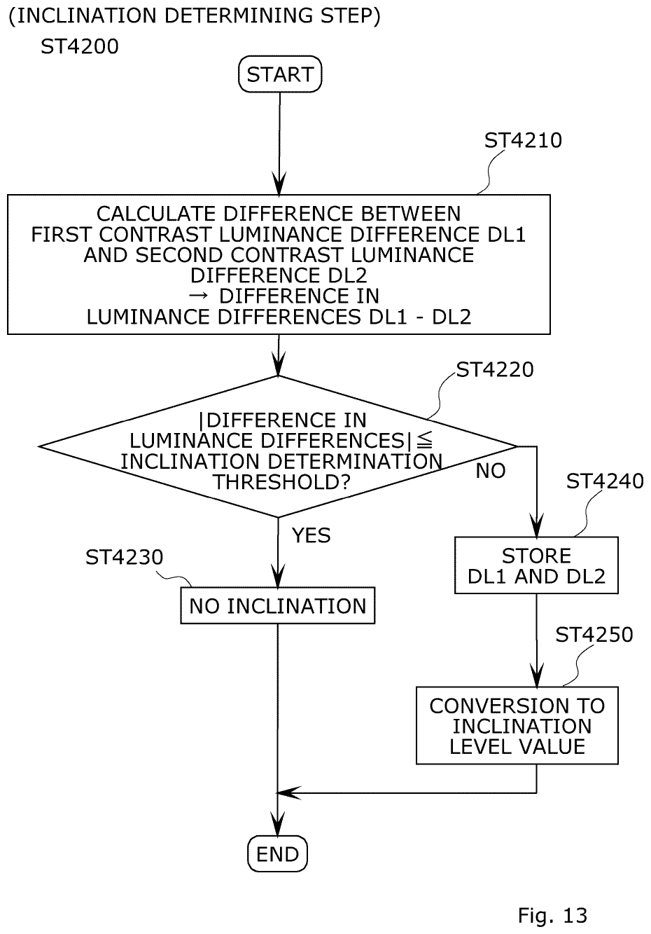

Since the first contrast luminance difference DL1 in the first contrast region and the second contrast luminance difference DL2 in the second contrast region are calculated in the filter processing step ST4100, the inclination determining step (ST4200) is performed next, returning to the flowchart in FIG. 11 (the contrast processing step ST4000). As shown in the flowchart in FIG. 13, first, the difference between the first contrast luminance difference DL1 in the first contrast region and the second contrast luminance difference DL2 in the second contrast region is calculated to be used as a difference in luminance differences ΔDL (=DL1−DL2) (ST4210). When the magnitude |ΔDL| of the difference in luminance differences ΔDL is less than or equal to a preset inclination determination threshold (ST4220: YES), it means that the left and right sides of the graduation plate 200 are imaged similarly and that the graduation plate 200 has no inclination (or an inclination within the acceptable range) (ST4230).

On the other hand, when the difference between the first contrast luminance difference DL1 and the second contrast luminance difference DL2 is greater (ST4220: NO), the graduation plate 200 is determined to be inclined with respect to the optical axis of the camera 40. The difference between the first contrast luminance difference DL1 and the second contrast luminance difference DL2 being greater means that there is a difference in sharpness of the left and right graduations in the image data. Since the focus of the camera 40 is on the graduation plate 200, which means that the graduation plate 200 is in focus within the range of depth of field, but there is a difference in sharpness between the left and right graduations in detail. Although the difference can be slight, this causes a difference in the detection of the graduations and pointer on the left and right sides in the image data when the graduation defection inspection and indication value error inspection are subsequently performed based on the image data.

When the magnitude |ΔDL| of the difference in luminance differences ΔDL exceeds the inclination determination threshold, the first contrast luminance difference DL1 and the second contrast luminance difference DL2 are stored. The first contrast luminance difference DL1 may be compared with the second contrast luminance difference DL2 to store which is greater (or smaller).

In addition, in ST4250, the magnitude of the difference in luminance differences ΔDL (=DL1−DL2) is converted to the inclination amount. This may be tabulated by calculating the relationship between the magnitude of the inclination angle of the graduation plate 200 with respect to the camera optical axis and the magnitude of the difference in luminance differences ΔDL in advance through preliminary experiments. Alternatively, instead of strictly converting the difference in luminance differences ΔDL into inclination angles at 0.1° intervals, an evaluation index that classifies the difference in luminance differences ΔDL into, for example, 10 levels according to the magnitude may be used.

Next, the guidance displaying step (ST5000) is described.

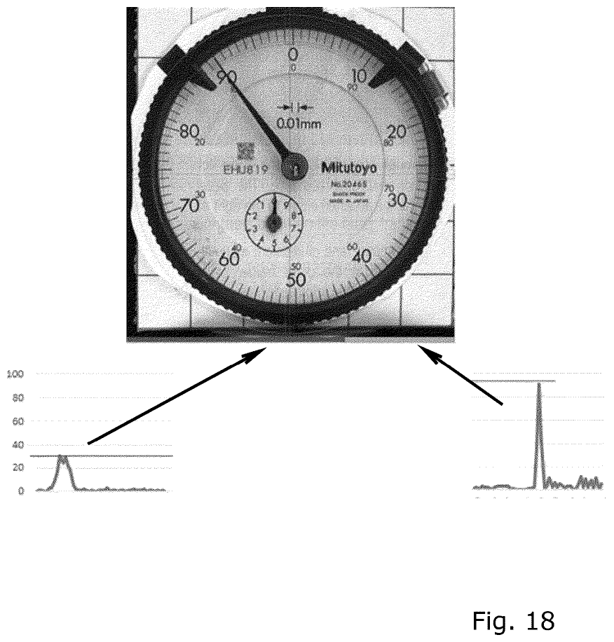

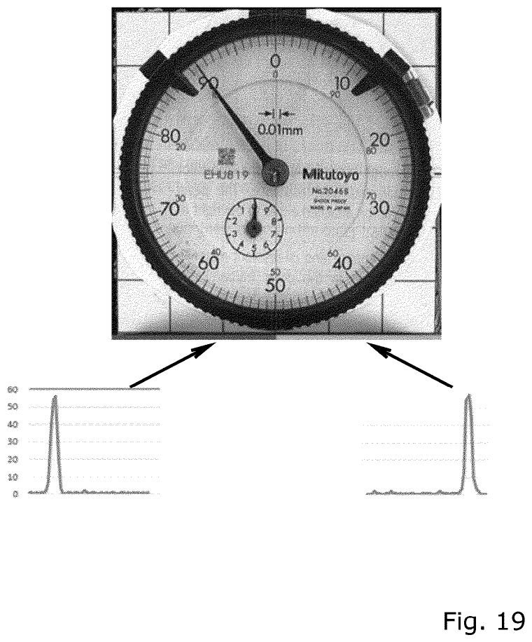

In the guidance displaying step (ST5000), the inclination (or inclination level) of the graduation plate 200 is visualized and displayed on a display device (monitor) to provide the operator with auxiliary information for adjusting the posture of the graduation plate 200. FIGS. 18 and 19 show examples of guidance display. In the examples in FIGS. 18 and 19, the graduation plate 200 is displayed on the monitor screen, and the balance of the inclination of the graduation plate 200 is indicated by the lengths of bars with colors (for example, blue and yellow) below the graduation plate 200. When the graduation plate 200 has no inclination, the left (yellow) bar and the right (blue) bar are the same length, as shown in FIG. 19. When the graduation plate 200 has an inclination, the lengths of the left and right bars are changed to represent the magnitude of the inclination. Here, the bar on the side with the smaller luminance difference (the first contrast luminance difference DL1 or the second contrast luminance difference DL2) is expressed longer. The operator refers to this guidance display, adjusts the posture of the graduation plate 200, and repeats the graduation-plate posture inspection several times in such a manner that the graduation plate 200 has the ideal posture shown in FIG. 19. This allows the measuring device 10 to be installed in such a manner that the graduation plate 200 directly faces the camera 40, and the operator to confirm that the graduation plate 200 and the camera 40 face each other.

It has not been possible to strictly determine whether the graduation plate 200 and the camera 40 face each other by simply visually observing the measuring device 10 (graduation plate 200) or by visually observing the image data obtained by imaging the measuring device 10 (graduation plate 200) on the screen. Therefore, it has not been possible to install the graduation plate 200 in such a manner that the graduation plate 200 and the camera 40 strictly face each other. For this reason, even the measuring device 10 that originally passed an inspection has failed the inspection for defects in the graduation plate 200 or for the accuracy of the measuring device 10, and this has caused problems such as the time and cost for investigating the cause of the problems and replacing parts, that were originally unnecessary. In this regard, the inventors have carefully examined the reasons why the inspection for defects in the graduation plate 200 or for the accuracy of the measuring device 10 is often not successfully performed, and after their careful research, they have realized that the basis of the problem is the installation posture of the measuring device 10 (graduation plate 200) and the camera 40. Therefore, the present invention has been made to strictly inspect the relative posture between the camera 40 and the graduation plate 200 by paying attention to the pixel values or the difference in pixel values (difference in pixel values of adjacent pixels) in the contrast regions (the first contrast region and the second contrast region) at symmetrical positions.

The present invention is not limited to the above exemplary embodiment, and can be modified as appropriate without departing from the gist.

The graduation plate 200 may be an analog graduation plate (analog dial) with graduations engraved or printed on an actual plate, or a graduation plate displayed on a digital display panel, such as an LCD or OLED panel.

In the above exemplary embodiment, the contrast is performed using graduations that are point symmetrical with respect to the center of the graduation plate 200 or symmetrical with respect to a virtual line passing through the center, but marks (for example, numbers, symbols, or the like) at symmetrical positions may be used, instead of graduations.

Although a one-dimensional differential filter is used in the above description, the processing is not limited thereto as long as it can emphasize the pixel value (luminance value) of the boundary between the background of the graduation plate and the print on the graduation plate (for example, marks such as graduations).

In the above exemplary embodiment, luminance values are used as pixel values, but color shades (black and white tones or RGB tones) may be used for contrast.
100 Measuring device inspection apparatus
10 Measuring device (measuring device to be inspected)
200 Graduation plate
12 Pointer
11 Contact point
20 Master gauge
21 Lid part
22 Reference spindle
23 Encoder
30 Stand part
31 Column
32 Bracket part
33 Base plate
34 Illumination installation stand
35 Camera installation stand
40 Camera
50 Illumination unit
300 Arithmetic processing unit
310 Inspection execution unit
400 Graduation-plate posture inspection unit
410 Brightness adjustment unit
420 Image data acquisition unit
430 Region calculation unit
431 Center calculation unit
432 Contrast region extraction unit
440 Contrast processing unit
441 Filter processing unit
442 Inclination determination unit
450 Guidance unit

1. A graduation-plate posture inspection method for inspecting a relative posture between a camera and a graduation plate, the method comprising:
acquiring image data on the graduation plate from the camera;
calculating a region by extracting a first contrast region and a second contrast region in the image data; and
contrasting the first contrast region with the second contrast region based on brightness or color,
wherein the relative posture between the camera and the graduation plate is inspected based on a contrast result by the contrasting.

2. The graduation-plate posture inspection method according to claim 1, wherein the first contrast region and the second contrast region are positioned on opposite sides of each other with a center of the graduation plate or a virtual straight line passing through the center of the graduation plate between the first contrast region and the second contrast region.

3. The graduation-plate posture inspection method according to claim 1, wherein the first contrast region and the second contrast region each contain a background-colored portion of the graduation plate and a printed or engraved mark.

4. The graduation-plate posture inspection method according to claim 1, wherein the contrasting comprises calculating a difference between pixel values or luminance values of adjacent pixels in each of the first contrast region and the second contrast region to contrast a magnitude of the difference in the first contrast region with a magnitude of the difference in the second contrast region.

5. The graduation-plate posture inspection method according to claim 1, further comprising:
before the calculating the region is performed,
adjusting a brightness by adjusting illumination and camera exposure in such a manner that an exposure time of the camera is the longest within a range in which luminance of pixels in the image data is not saturated, and that the number of pixels having brightness above a predetermined threshold is a predetermined fixed count value or more.

6. The graduation-plate posture inspection method according to claim 1, wherein the calculating the region comprises:
calculating a center of the graduation plate that comprises:
calculating a line connecting a first pair of graduations at point symmetrical positions with respect to a center of the graduation plate, and a line connecting a second pair of graduations at point symmetrical positions with respect to a center of the graduation plate; and
setting an intersection point of the line connecting the first pair of graduations and the line connecting the second pair of graduations as the center of the graduation plate.

7. The graduation-plate posture inspection method according to claim 6, wherein the calculating the center comprises:
searching for edge coordinates on one side from one side of each graduation in a width direction using a predetermined algorithm, and edge coordinates on the other side from the other side of the graduation in the width direction using the same algorithm with an orientation different from the predetermined algorithm; and
calculating the line connecting each pair of graduations by setting a midpoint between the edge coordinates on the one side and the edge coordinates on the other side as center coordinates of a width of each graduation and connecting the center coordinates of each pair of graduations.

8. A recording medium storing a graduation-plate posture inspection program causing a computer to execute:
acquiring image data on a graduation plate from a camera;
calculating a region by extracting a first contrast region and a second contrast region in the image data; and
contrasting the first contrast region with the second contrast region based on brightness or color,
wherein a relative posture between the camera and the graduation plate is inspected based on a contrast result by the contrasting.

9. A graduation-plate posture inspection apparatus configured to inspect a relative posture between a camera and a graduation plate, the apparatus comprising a processor configured to:
acquire image data on the graduation plate from the camera;
extract a first contrast region and a second contrast region in the image data; and
contrast the first contrast region with the second contrast region based on brightness or color,
wherein the relative posture between the camera and the graduation plate is inspected based on a contrast result by the contrast.

10. The graduation-plate posture inspection apparatus according to claim 9, wherein a base plate extending from a stand part configured to hold a measuring device to be inspected including the graduation plate to be inspected is provided, and
the camera is installed on the base plate.

11. The graduation-plate posture inspection apparatus according to claim 9, wherein the stand part is installed on a master gauge to enable a relative position and posture of the measuring device to be inspected, the master gauge, and the camera to be fixed.
